(19) United States
(12) Patent Application Publication
(10) Pub. No.: US 2024/0338613 A1
(43) Pub. Date: Oct. 10, 2024

(54) PREDICTION OF CANCELLATIONS OF BOOKED EVENTS

(71) Applicant: Garuda Labs, Inc., San Francisco, CA (US)

(72) Inventors: Debarshi Kumar Kar, San Ramon, CA (US); Parv Ajay Oberoi, Mumbai (IN); Angela Kaiyuan Han, Sunnyvale, CA (US)

(21) Appl. No.: 18/540,801

(22) Filed: Dec. 14, 2023

(30) Foreign Application Priority Data
Apr. 7, 2023 (IN) 202321026187

(51) Int. Cl. G06Q 10/02

(52) U.S. Cl. CPC G06Q 10/02

(57) ABSTRACT

Various embodiments of an apparatus, methods, systems and computer program products described herein are directed to a Booking Engine. The Booking Engine generates a prediction, for one of a plurality of distinct sequential time ranges defined as occurring prior to a start of an event, regarding a likelihood of an occurrence of an unattendance by one or more individuals at the event. Each individual is represented by a respective user account. Based on the prediction, the Booking Engine triggers one or more booking actions specific to a particular time range of the prediction. The Booking Engine triggers one or more notifications in accordance with the one or more booking actions for the event.

### BACKGROUND

The approaches described in this section could be pursued, but are not necessarily approaches that have previously been conceived or pursued. Therefore, unless otherwise indicated, it should not be assumed that any of the approaches described in this section qualify as prior art merely by virtue of their inclusion in this section.

In the field of computer science, artificial intelligence (“AI”) networks, such as neural networks and deep learning networks, are increasingly being employed to solve a variety of tasks and challenging problems, often with great success. Such AI networks can consist of computational graphs with nodes representing computational operations (“ops”), and connections in between those ops. Each op computes something on input data in order to produce output data. Within AI networks there are fairly predefined ops, and there can be, e.g., hundreds or thousands of these ops. Such ops can represent such computational tasks as matrix multiplication and convolution, often using many pieces of input data from within the network. An AI network can be thought of at one level as a list of ops, or operations, that get executed in a particular order to produce an output.

### SUMMARY

Conventional systems are deficient with respect to ensuring whether events available for booking by one or more user accounts will actually be attended by individuals represented by user accounts that requested bookings for that event—or that are qualified to send booking requests for that event.

Various embodiments of an apparatus, methods, systems and computer program products described herein are directed to a Booking Engine. In some embodiments, an online platform that implements the Booking Engine may allow for one or more businesses, represented by respective business user accounts, to post openings for events. For example, an event may be an available job shift(s) and a post for an available job shifts may be a job shift post.

The online platform further includes a plurality of worker user accounts who may view and/or interact with the job shift posts. One or more of the worker user accounts may send requests to book a job shift represented by a particular job shift post. An individual represented by the requesting worker user account that books a job shift via the online platform may then ultimately physically attend the requested job shift to perform occupational services and/or professional services in exchange for payment (or wages). However, some individuals may book a particular job shift on the online platform via a corresponding worker user account but may not, in reality, show up to actually perform occupational services and/or professional services during that booked job shift.

A job shift may be posted on the online platform and the Booking Engine provides advantages of monitoring and managing different risk appetites. An ideal result is that a qualified individual represented by their worker user account successfully books the job shift, does not send a job shift booking cancellation request before the job shift and actually personally reports to the job shift to complete the work. Varying levels of risk are connected to unqualified worker user accounts seeking to book job shifts ahead of more qualified worker user accounts and/or an unreliable worker user account successfully booking a job shift but never actually physically attends the job shift to complete the tasks and duties required by the business. Different time ranges prior to the beginning of a job shift represent different levels of risk connected to the urgency of ensuring a qualified and reliable worker user account successfully books a job shift post.

The Booking Engine continually identifies different types of segments of worker user accounts and different types of segments of business user accounts based on features that correspond to activities of the user accounts, such as, for example, submitted posts, user account age, booking requests, cancellations and successful completion of jobs. The Booking Engine determines and updates cut off scores for respective pairings of the worker and business user segments. That is, each different segment pairing may have its own cut off score, which can be further continually updated by the Booking Engine.

In various embodiments, each segment pairing may have a plurality of different cut off scores. For example, a notification cut off score and an event booking cut off score. Before sending a notification to a worker user account about a posted job shift, the Booking Engine determines if features of the worker user account results in a score that meets a notification cut off score. Before confirming that a worker user account has successfully booked a posted job shift, the Booking Engine determines if features of the worker user account results in a score that meets an event booking cut off score.

According to one or more embodiments, the Booking Engine implements an objective function algorithm(s) to determine and update cut off scores for a respective segment pairing between a worker segment and a business segment. There may be a plurality of different segment pairings whereby the Booking Engine determines one or more types of cut off scores for each segment pairing.

According to various embodiments, when the Booking Engine initiates an action regarding a particular worker user account, the Booking Engine determines whether that particular worker user account satisfies a cut off score for a given segment pairing. For example, in order to notify a first worker user account about a posted job shift, the Booking Engine determines whether the first worker user account satisfies a first cut off score for a segment pairing between a worker segment to which the first worker user account belong and a business segment that includes a business user account that posted the job shift. In other embodiments, the Booking Engine determines whether the first worker user account satisfies a second cut off score for the segment pairing before allowing the first worker user account to successfully book a job shift and/or before confirming success of a booking request.

Various embodiments described herein are directed to predicting a likelihood that a particular job shift may be booked but ultimately unattended by individuals represented by worker user accounts that booked the particular job shift. In addition or alternatively, embodiments of the Booking Engine are further directed to predicting a likelihood that a particular job shift may be booked within a certain time range prior to a start time of the particular job shift. An embodiment(s) of the Booking Engine generates various types of predictions during different sequential time ranges occurring prior to a start time of an event (i.e. a particular job shift) described in a job shift post. Based on the prediction(s), the Booking Engine initiates one or more booking actions appropriate for the particular time range during which the prediction was generated.

According to various embodiments, the Booking Engine generates a prediction, for one of a plurality of distinct sequential time ranges defined as occurring prior to a start of an event, regarding a likelihood of an occurrence of an unattendance by one or more individuals at the event. Each individual is represented by a respective user account. Each distinct time range may represent a different level of risk connected to attempting to ensure a qualified and reliable individual represented by their worker user account successfully books an event (such as a job shift post). Based on the prediction, the Booking Engine triggers one or more booking actions specific to a particular time range of the prediction. The Booking Engine triggers one or more notifications in accordance with the one or more booking actions for the event.

In various embodiments, the Booking Engine calls or runs a model(s) that corresponds to a particular time range (i.e. time range mode) to determine a cut off score(s) for one or more segment pairings (worker and business user account pairing). The Booking Engine may further call or run a time range model for a particular time range to determine if a worker user account(s) meets a cut off score. It is understood that various types of features may be input by the Booking Engine into a time range model, where those input features are highly correlated with an output prediction that accounts for the level of risk appetite associated with the corresponding time range. Different time ranges may be associated with different levels of acceptable risks. Therefore, one or more features input into a first time range model during a first time range may be different than one or more features input into a second time range model for a second time range. In addition, a weight assigned to a feature input into the first time range model may different than another weight assigned to the same feature when it is input into the second time range model.

Various embodiments include a module(s) and/or one or more functionalities to redact privacy information/data, to encrypt information/data and to anonymize data to ensure the confidentiality and security of user and platform information/data as well as compliance with data privacy law(s) and regulations in the United States and/or international jurisdictions.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary environment in which some embodiments may operate.

FIG. 2 is a diagram illustrating an exemplary method that may be performed in some embodiments.

FIG. 3A is a diagram illustrating an exemplary method that may be performed in some embodiments.

FIG. 3B is a diagram illustrating an exemplary environment in which some embodiments may operate.

FIG. 4 is a diagram illustrating an exemplary method that may be performed in some embodiments.

FIG. 5 is a diagram illustrating an exemplary method that may be performed in some embodiments.

FIG. 6 is a diagram illustrating an exemplary method that may be performed in some embodiments.

FIG. 7 is a diagram illustrating an exemplary environment in which some embodiments may operate.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

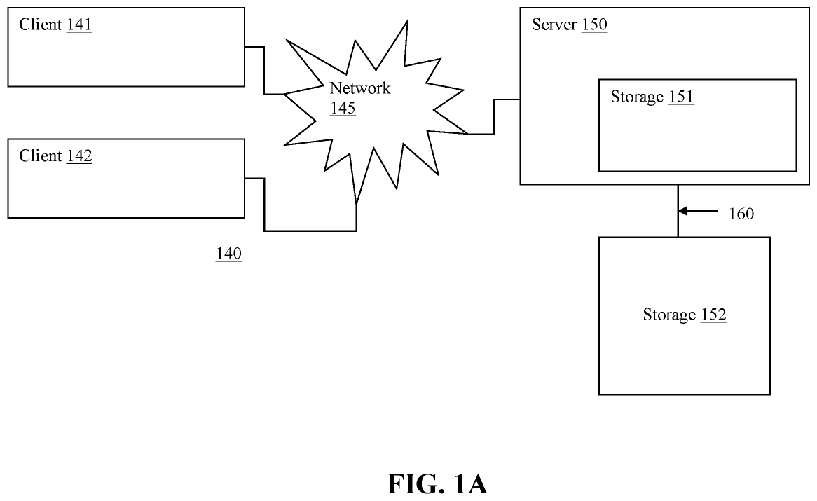

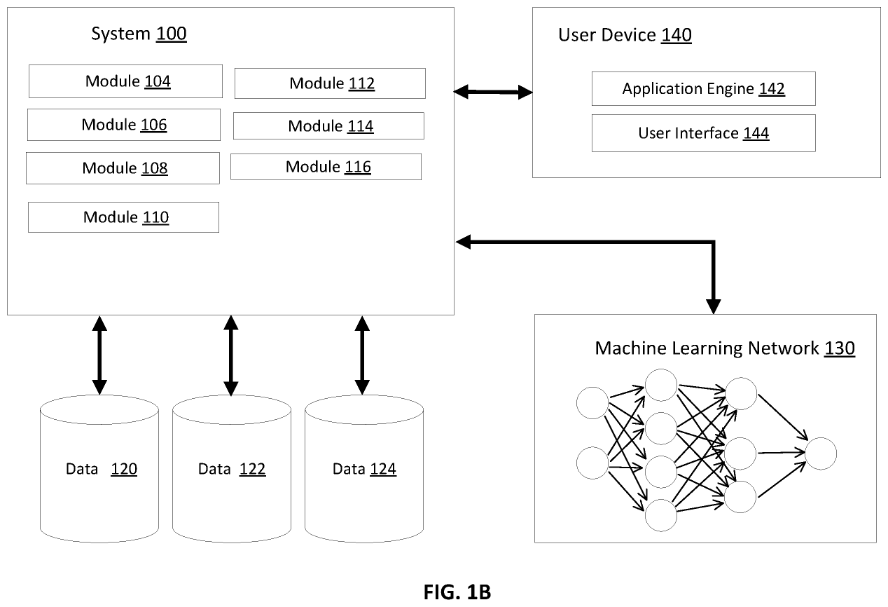

A diagram of exemplary network environment in which embodiments may operate is shown in FIG. 1A. In the exemplary environment 140, two clients 141, 142 are connected over a network 145 to a server 150 having local storage 151. Clients and servers in this environment may be computers. Server 150 may be configured to handle requests from clients.

The exemplary environment 140 is illustrated with only two clients and one server for simplicity, though in practice there may be more or fewer clients and servers. The computers have been termed clients and servers, though clients can also play the role of servers and servers can also play the role of clients. In some embodiments, the clients 141, 142 may communicate with each other as well as the servers. Also, the server 150 may communicate with other servers.

The network 145 may be, for example, local area network (LAN), wide area network (WAN), telephone networks, wireless networks, intranets, the Internet, or combinations of networks. The server 150 may be connected to storage 152 over a connection medium 160, which may be a bus, crossbar, network, or other interconnect. Storage 152 may be implemented as a network of multiple storage devices, though it is illustrated as a single entity. Storage 152 may be a file system, disk, database, or other storage.

In an embodiment, the client 141 may perform the method 200 or other method herein and, as a result, store a file in the storage 152. This may be accomplished via communication over the network 145 between the client 141 and server 150. For example, the client may communicate a request to the server 150 to store a file with a specified name in the storage 152. The server 150 may respond to the request and store the file with the specified name in the storage 152. The file to be saved may exist on the client 141 or may already exist in the server's local storage 151. In another embodiment, the server 150 may respond to requests and store the file with a specified name in the storage 151. The file to be saved may exist on the client 141 or may exist in other storage accessible via the network such as storage 152, or even in storage on the client 142 (e.g., in a peer-to-peer system).

In accordance with the above discussion, embodiments can be used to store a file on local storage such as a disk or on a removable medium like a flash drive, CD-R, or DVD-R. Furthermore, embodiments may be used to store a file on an external storage device connected to a computer over a connection medium such as a bus, crossbar, network, or other interconnect. In addition, embodiments can be used to store a file on a remote server or on a storage device accessible to the remote server.

Furthermore, cloud computing is another example where files are often stored on remote servers or remote storage systems. Cloud computing refers to pooled network resources that can be quickly provisioned so as to allow for easy scalability. Cloud computing can be used to provide software-as-a-service, platform-as-a-service, infrastructure-as-a-service, and similar features. In a cloud computing environment, a user may store a file in the “cloud,” which means that the file is stored on a remote network resource though the actual hardware storing the file may be opaque to the user.

FIG. 1B illustrates a block diagram of an example system 100 for a Booking Engine that includes a prediction module 104, a booking actions module 106, a notification module 108, a machine learning module 110, a time range module 112, a post module 114 and a user interface (U.I.) module 116. The system 100 may communicate with a user device 140 to display output, via a user interface 144 generated by an application engine 142.

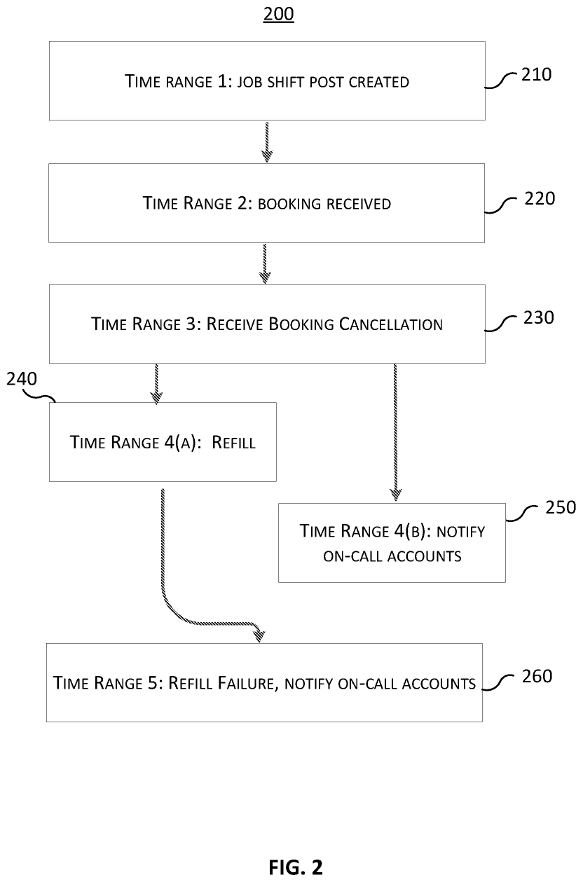

The prediction module 104 of the system 100 may perform functionality related to generation of predictions as illustrated in FIGS. 2, 3A, 3B, 4, 5, 6 (“FIGS. 2-6”).

The booking actions module 106 of the system 100 may perform functionality related to triggering actions for various time ranges as illustrated in FIGS. 2-6.

The notifications module 108 of the system 100 may perform functionality illustrated in FIGS. 2-6, such as, for example, functionality related to received booking requests, received cancellations, sending notifications, receiving job shift posts and managing job shift post access.

The machine learning module 110 of the system 100 may perform functionality related to training, implementing and executing one or more machine learning models 130 as illustrated in FIGS. 2-6.

The time range module 112 of the system 100 may perform functionality related to triggering, determining, detecting, calculating, maintaining and terminating a time range, as illustrated in FIGS. 2-6.

The post module 114 of the system 100 may perform functionality related to event posts (such as job shift posts) as illustrated in FIGS. 2-6.

The user interface module 116 of the system 100 may display information based on functionality as illustrated in FIGS. 2-6.

While the databases 120, 122 and 124 are displayed separately, the databases and information maintained in a database may be combined together or further separated in a manner the promotes retrieval and storage efficiency and/or data security.

Embodiments of the Booking Engine are further directed to continually generating, identifying and/or updating a plurality of different worker segments. A worker segment may include one or more respective worker user accounts having similar features and/or attributes. For example, a first worker segment may include worker user accounts that each have booked and completed less than 3 job shifts via the online platform. For example, a second worker segment may include worker user accounts that each have booked and completed at least 10 job shifts via the online platform.

The Booking Engine continually generates, identifies and/or updates different business segments. A business segment may include one or more business user accounts having similar features and/or attributes. For example, a first business segment may include business user accounts that each have recently joined the online platform within the past 30 days. For example, a second business segment may include business user accounts that each have posted at least 20 job shifts on the online platform. For example, a third business segment may include business user accounts that each have posted at least 30 job shifts on the online platform.

For a given pairing between a worker segment and a business segment (i.e. a given segment pairing), the Booking Engine utilizes and implements an objective function algorithm(s) to determine a cut off score for that giving pairing segment. It is understood that the Booking Engine utilizes and implements an objective function algorithm(s) to determine various cut off scores for a plurality of different segment pairings. A cut off score for a segment pairing represents an acceptable risk threshold that a worker user account must satisfy in order to be notified about a job shift or be allowed to book a job shift. For example, the Booking Engine determines a first cut off score for a pairing between a first worker segment and a first business segment. For example, the Booking Engine determines a second cut off score for a pairing between the first worker segment and a second business segment. For example, the Booking Engine determines a third cut off score for a pairing between the first worker segment and a third business segment. For example, the Booking Engine determines a fourth cut off score for a pairing between a second worker segment and the second business segment.

According to various embodiments, a cut off score for a segment pairing between the first worker segment and the first business segment represents a low risk appetite because of the unacceptable risk of allowing new or relatively inactive worker user accounts (i.e. worker user accounts that have completed less than 3 job shifts) to book a job shift posted by a business user account in the first business segment (i.e. business user accounts that recently joined the online platform within the past 30 days).

As shown in flowchart 200 of FIG. 2, a first-time range 210 may be defined as starting upon receipt of a job shift post by a business user account. Predictions generated during the first-time range 210 may be output by calling one or more models that are defined for the first-time range 210.

A subsequent second time range 220 may start in response to receipt of a booking for the job shift post by one or more worker user accounts. Predictions generated during the second time range 220 may be output by calling one or more models that are defined for the second time range 220. A subsequent third time range 230 starts when the Booking Engine receives a cancellation(s) of a booking from one or more worker user accounts—and that cancellation(s) is received within a first defined period of time remaining prior to a start time of the job shift. For example, the third time range 230 may be triggered based on receiving a booking cancellation from a worker account and the cancellation is received 24 hours prior to a start time of the job shift. In another example, the third time range 230 may be triggered based on receiving a booking cancellation from a worker account and the cancellation is received 48 hours prior to a start time of the job shift. Predictions generated during the third time range 230 may be output by calling one or more models that are defined for the third time range 230.

In one or more embodiments, based on triggering the third time range 230 due to a booking cancellation(s), the Booking Engine may initiate a time range 240 (i.e. refill time range) that allows for one or more other worker user accounts to initiate a booking for the job shift post. The refill time range 240 allows for the possibility of job shift post, which is now needing to be booked due to a cancellation(s), to be re-booked by booking requests initiated by the other worker user accounts. Predictions generated during the refill time range 240 may be output by calling one or more models that are defined for the refill time range 240.

In the alternative, instead of the triggering the refill time range 240, the Booking Engine may send notifications to one or more on-call user accounts. The notifications include instructions for the one or more on-call user account to send booking requests for the job shift post during another time range 250.

If, during the refill time range 240, no additional bookings have been confirmed for the job shift post and there is now only a second defined period of time remaining prior to the start time of the job shift (e.g. 3 hours before the start of the job shift), the Booking Engine initiates another time range 260 for sending notifications to the on-call user accounts to send booking requests for the job shift post. For example, if at the end of the refill time range 240, the Booking Engine has not received any booking requests from the other worker user accounts, and there is only 3 hours before the start of the job shift left, then the Booking Engine triggers sending notifications to the on-call user accounts. Predictions generated during the other time range 260 may be output by calling one or more models that are defined for the other time range 260. It is understood that each time range 210, 220, 230, 240, 250, 260 may represent a different level of risk appetite connected to attempting to ensure a qualified and reliable individual represented by their worker user account successfully books an event (such as a job shift post). For example, a low level of risk appetite represents a high degree of aversion towards allowing for the chance that an unqualified and/or unreliable worker user account is notified about a job shift post and/or is allowed to book the job shift post.

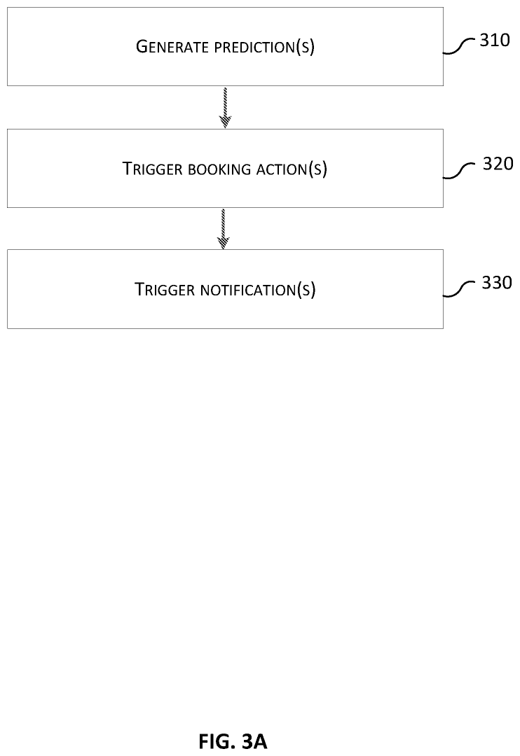

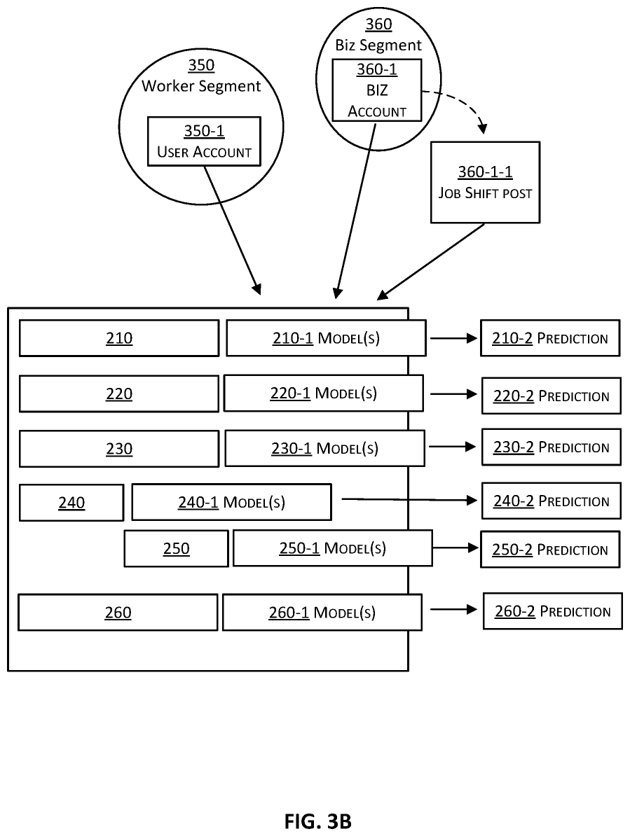

As shown in flowchart 300 of FIG. 3A, at step 310, the Booking Engine generates a prediction, for one of a plurality of distinct sequential time ranges 210, 220, 230, 240, 250, 260 defined as occurring prior to a start of an event, regarding a likelihood of an occurrence of an unattendance by one or more individuals at the event (i.e. job shift). Each individual is represented by a respective user account (i.e. worker user account);

At step 320, based on the prediction, the Booking Engine triggers one or more booking actions specific to a particular time range 210, 220, 230, 240, 250, 260 of the prediction. At step 330, the Booking Engine triggers one or more notifications in accordance with the one or more booking actions for the event.

As shown in FIG. 3B, each time range 210, 220, 230, 240, 250, 260 of the Booking Engine may be associated with a particular machine learning model(s) 210-1, 220-1, 230-1, 240-1, 250-1, 260-1. For example, the models 210-1, 220-1, 230-1, 240-1, 250-1, 260-1 may be different than each other. Some of the models 210-1, 220-1, 230-1, 240-1, 250-1, 260-1 may have similar portions. A model 210-1, 220-1, 230-1, 240-1, 250-1, 260-1 may be based on one or more machine learning algorithms. Each model 210-1, 220-1, 230-1, 240-1, 250-1, 260-1 outputs a respective prediction 210-2, 220-2, 230-2, 240-2, 250-2, 260-2 regarding a likelihood of an occurrence of an unattendance by an individual(s) at a job shift booked via a user account associated with that individual. In addition or in the alternative, each model 210-1, 220-1, 230-1, 240-1, 250-1, 260-1 outputs a respective prediction 210-2, 220-2, 230-2, 240-2, 250-2, 260-2 regarding a likelihood of whether a job shift post will or will not receive a booking request.

The Booking Engine receives input that includes features of a worker user account(s) 350-1 that belong to a particular worker segment(s) 350, features of a business user account(s) 360-1, in a particular business segment(s) 360 that creates a job shift post(s) 360-1-1 and features of the job shift post(s) 360-1-1. The Booking Engine feeds the input into a particular model(s) from the time range models 210-1, 220-1, 230-1, 240-1, 250-1, 260-1 and outputs a prediction. It is understood that each of the models 210-1, 220-1, 230-1, 240-1, 250-1, 260-1 may use (or place a greater/lesser weight on) different features of a worker user account, business user account and/or job shift post that reflects a particular risk appetite for the corresponding time range. For example, if the current time range is the second time range 220, the Booking Engine inputs various features into the corresponding model(s) 220-1 for the second time range. For example, if the current time range is the third time range 230, the Booking Engine inputs various features into the corresponding model(s) 230-1 for the third time range 230. It is understood that at least some of the types of features input into the models 220-1, 230-1 may be different.

In various embodiments, the Booking Engine calls or runs a model(s) that corresponds to a particular time range to determine a cut off score(s) for one or more segment pairings (worker and business user account pairing). The Booking Engine may further call or run a model(s) that corresponds to a particular time range to determine if a worker user account(s) meets a cut off score.

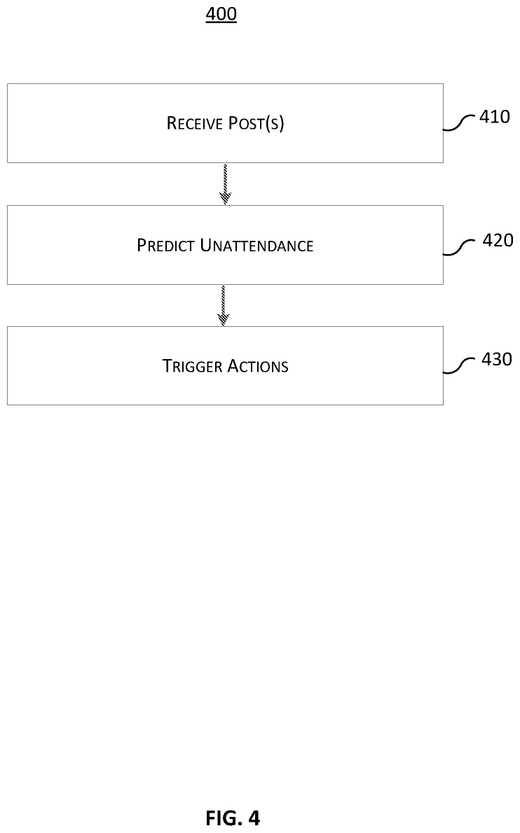

As shown in flowchart 400 of FIG. 4, during the first time range 210, the Booking Engine receives the job shift post prior to the start of the job shift. (Step 410) For example, a business user account may post a notice indicating an availability (i.e. day, start time, end time) of one or more shifts for a type of job. The Booking Engine may access one or more different segments of worker user accounts and identify one or more worker user accounts that are relevant to the job shift post. For example, the Booking Engine identifies a first worker user account and a second worker user account in a particular worker segment that both meet a notification cut off score, determined via implementation of an objective function algorithm, for the pairing of that particular worker segment and the business segment for the business user account that posted the job shift. In other words, the Booking Engine determines that the first and the second worker accounts in their particular worker segment satisfy a risk appetite with respect to allowing them to be notified about the job shift. It is understood that the Booking Engine identifies the first and second worker user accounts as being relevant to the job shift post, in accordance with the notification cut off, before the identified worker user accounts send a booking request.

The Booking Engine generates unattendance predictions. (Step 420). The Booking Engine predicts a first unattendance likelihood for a possible first booking of the event by the first worker user account. For example, the Booking Engine determines whether the first user worker account also meets an event booking cut off (or cut off score) for the segment pairing. The Booking Engine predicts a second unattendance likelihood for a possible second booking of the event by the second worker user account. That is, the Booking Engine generates a prediction indicating a likelihood that an individual that corresponds with the first or second worker user account will ultimately not attend the job shift-if that worker user account were to send a booking request. For example, the Booking Engine determines whether the second user worker account also meets an event booking cut off for the segment pairing.

The Booking Engine triggers various actions based on the predictions. (Step 430). Due to the first unattendance likelihood, the Booking Engine may block user interaction activity of the first user account with the event. For example, the Booking Engine may generate a prediction that, if the first worker user account were to send a booking request for the job shift post, that there is a high likelihood that the individual that corresponds with the first worker user account will ultimately fail to physically attend the booked worked shift. Based on the prediction with respect to the first worker user account, the Booking Engine blocks the first worker user account from having access to the job shift post on the online platform. The first worker user account, although at first identified by the Booking Engine as relevant to the job shift post, will not be able to view or interact with the job shift post on the online platform.

Due to the second unattendance likelihood, the Booking Engine allows user interaction activity of the second user account with the event. The Booking Engine may send a notification of the event to the second user account. For example, the Booking Engine may generate a prediction that, if the second worker user account were to send a booking request for the job shift post, that there is a low likelihood that the individual that corresponds with the second worker user account will ultimately fail to physically attend the booked worked shift. Based on the prediction with respect to the second worker user account, the Booking Engine provides the second worker user account with access to the job shift post on the online platform. In addition, the Booking Engine may send a notification regarding the job shift post to the second worker user account. The notification may be a recommendation that the second worker user account send a booking request for the job shift post. It is understood that, according to Step 430, due to the first and second unattendance likelihoods, the Booking Engine concurrently provides the second user account access permission to initiate interaction activity with the job shift post while denying user interaction activity of the first user account with the job shift post.

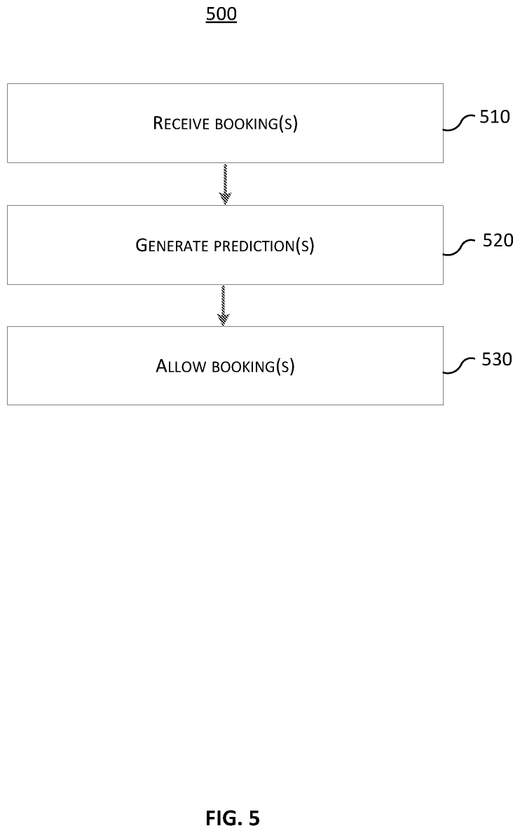

As shown in flowchart 500 of FIG. 5, the Booking Engine receives a booking of the job shift post from a first user account. (Step 510) Receipt of the booking defines a start of the second time rage 220. The Booking Engine triggers initiation of an instance of the second time range. 220. The Booking Engine predicts a first unattendance likelihood for the first user account that has booked the job shift. (Step 520).

Due to the first unattendance likelihood, the Booking Engine allows for overbooking of the job shift post from one or more additional user accounts. (Step 530) The Booking Engine generates a prediction indicating that there is a high likelihood that the individual that corresponds with the first worker user account that has booked the job shift will ultimately fail to physically attend the booked worked shift. Based on the prediction, the Booking Engine sets a status of the job shift post as being active and available for booking by other worker user accounts. In some embodiments, the job shift post may have already been booked by a maximum allowable worker user accounts. If one or more of those worker user accounts are associated with a high likelihood of unattendance, the Booking Engine maintains the status of the job shift post as active and available and allows for other worker user accounts to send booking requests such that the job shift post may ultimately become overbooked, where there are more worker user accounts that have booked a job shift that corresponds with the job shift post than there are actual available job shifts. For example, the Booking Engine may set an override flag associated with the job shift post indicating that additional user accounts are currently allowed to send respective booking requests for the job shift post despite already being booked by other user accounts due to the predicted high likelihood of unattendance.

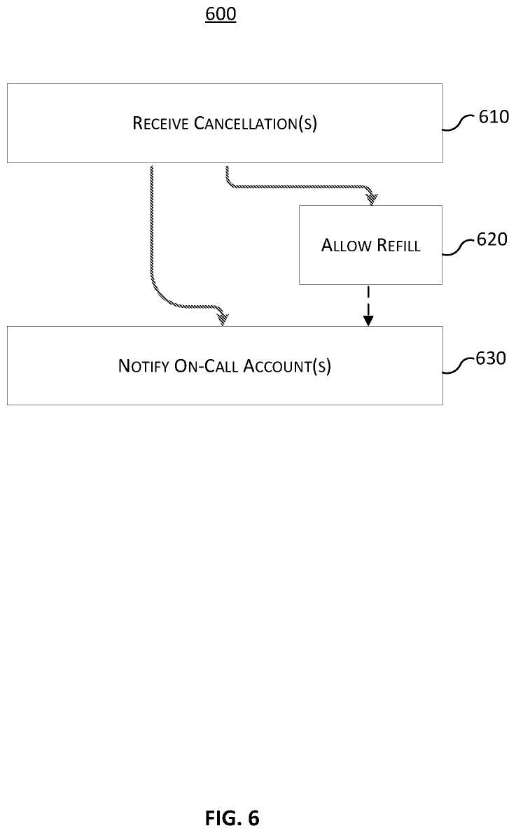

As shown in flowchart 600 of FIG. 6, the Booking Engine receives a confirmation from a first user account that unattendance of the job shift will occur. Step 610) For example, a first worker user account that previously booked an available job shift that corresponds to a job shift post sends a notification that the individual associated with the first worker user account will not attend the job shift. For example, the notification may be a booking cancellation. The Booking Engine determines that the confirmation is received within a defined time range prior to the start of the job shift and triggers a subsequent time range 230. For example, the Booking Engine determines that the booking cancellation is received within 24 hours prior to start of the job shift. Based on the determination, the Booking Engine triggers initiation a particular time range 230.

During time range 230, the Booking Engine generates a first prediction of whether a new booking request(s) will be received from one or more user accounts having a current permission to book the event. For example, the Booking Engine generates a prediction in order to assess whether the job shift post will be rebooked merely as a consequence of user activity on the online platform as opposed to any specific booking recommendations send to various worker user accounts. Based on based on the first prediction satisfying the threshold, the Booking Engine allows for a refill time range 240 during which a possible request to book the event may be received from the one or more user accounts having the current permission to book the event. (Step 620). The Booking Engine initiates an instance of the refill time range 240 in order to allow for the possibility of receiving additional booking requests from various worker user accounts.

In the alternative, if the first prediction fails to satisfy the threshold, the Booking Engine does not trigger initiation of the refill time range 240. Instead, the Booking Engine initiates an alternative time range 250, during which the Booking Engine identifies and notifies one or more on-call user accounts having a respective reservation for a period of time that includes a start time of the event. (Step 630) For example, an on-call user account(s) is associated with a reserved time slot that coincides with a timing of the job shift that corresponds with the job shift post. It is understood that an on-call user account(s) may have reserved a time slot prior to—or after—receipt of the job shift post. Reservation of the time slot indicates an individual that corresponds with an on-call user account will attend a job shift that coincides with the reserved time slot. Since the first prediction indicates that the job shift post will not be refilled by relying on worker user account activity on the online platform, the Booking Engine triggers the alternative time range 250 and sends notifications to the one or more on-call user accounts regarding the job shift post.

In one or more embodiments, returning to implementation of the refill time range 240, the Booking Engine detects initiation of a subsequent time range 260 (e.g. 3 hours prior to the start of the job shift) and that the job shift post has not received any bookings during the refill time range 240. The Booking Engine sends a notification to at least one of the on-call user accounts to initiate a booking of the job shift post.

Various embodiments of the Booking Engine may use any suitable machine learning training techniques to train the machine learning network(s) related to any of the models 210-1, 220-1, 230-1, 240-1, 250-1, 260-1. For example, such machine learning training techniques may include, but are not limited to, a neural net based algorithm, such as Artificial Neural Network, Deep Learning; a robust linear regression algorithm, such as Random Sample Consensus, Huber Regression, or Theil-Sen Estimator; a kernel based approach like a Support Vector Machine and Kernel Ridge Regression; a tree-based algorithm, such as Classification and Regression Tree, Random Forest, Extra Tree, Gradient Boost Machine, or Alternating Model Tree; Naïve Bayes Classifier; and other suitable machine learning algorithms.

In one or more embodiments, various types of features input by the Booking Engine into the models 210-1, 220-1, 230-1, 240-1, 250-1, 260-1 may be correlated with a value of an output prediction. Such features may be based on data representing any of the following: booking cancellation history of a worker user account, various types and volume of user activity within the online platform of a worker user account, an amount of time remaining prior to a start of a job shift when a booking was received, whether a job shift post indicates that a W2 tax form will be generated for the corresponding job shift, wage rate data for a worker user account and job post shift wage rate.

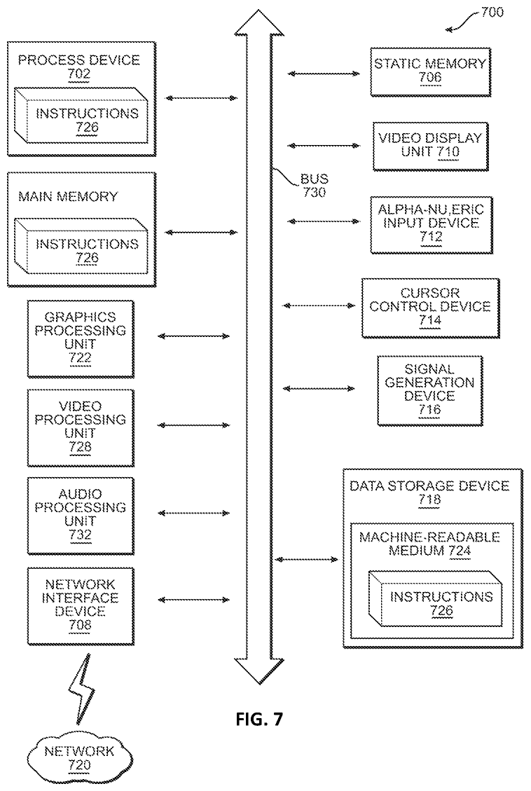

FIG. 7 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730.

Processing device 702 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a computer-readable medium) on which is stored one or more sets of instructions or software 726 embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In one implementation, the instructions 726 include instructions to implement functionality corresponding to the components of a device to perform the disclosure herein. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method comprising:
generating a prediction, for one of a plurality of distinct sequential time ranges occurring prior to a start of an event, regarding a likelihood of an occurrence of an unattendance by one or more individuals at the event, each individual represented by a respective user account;
based on the prediction, triggering one or more booking actions specific to a particular time range of the prediction; and
triggering one or more notifications in accordance with the one or more booking actions for the event.

2. The computer implemented method of claim 1, wherein generating a prediction comprises:
receiving an indication of the event during a first time range prior to the start of the event;
predicting a first unattendance likelihood for a possible first booking of the event by a first user account prior to actual receipt of a booking request from the first user account;
predicting a second unattendance likelihood for a possible second booking of the event by a second user account prior to actual receipt of a booking request from the second user account;
wherein triggering one or more booking actions specific to a particular time range of the prediction comprises:
due to the first and the second unattendance likelihoods, concurrently providing the second user account access permission to initiate interaction activity with the event while denying user interaction activity of the first user account with the event; and
due to the second unattendance likelihood, allowing user interaction activity of the second user account with the event; and
wherein triggering one or more notifications comprises:
sending a notification of the event to the second user account.

3. The computer implemented method of claim 1, wherein generating a prediction comprises:
receiving a booking of the event from a first user account;
triggering a time range subsequent to an initial time range based on the received booking; and
predicting a first unattendance likelihood for the booking of the event by a first user account;
wherein triggering one or more booking actions specific to a particular time range of the prediction comprises:
due to the first unattendance likelihood, allowing for overbooking of the event from one or more additional user account; and
wherein triggering one or more notifications comprises:
sending a request to a second user account to book the event after a total booking threshold for the event has been satisfied.

4. The computer implemented method of claim 1, wherein generating a prediction comprises:
receiving a confirmation, within a defined time range prior to the start of the event, from a first user account that unattendance of the event will occur;
generating a first prediction of whether a booking request will be received from one or more user accounts having a current permission to book the event;
wherein triggering one or more booking actions specific to a particular time range of the prediction comprises:
based on the first prediction satisfying a threshold, allowing for a period of time during which a possible request to book the event may be received from the one or more user accounts having the current permission to book the event.

5. The computer implemented method of claim 4, wherein triggering one or more notifications comprises:
sending a respective notification of the event to the one or more user accounts having the current permission to book the event.

6. The computer implemented method of claim 4, wherein triggering one or more booking actions specific to a particular time range of the prediction comprises:
based on the first prediction failing to satisfy the threshold, identifying one or more on-call user accounts having a respective reservation for a period of time that includes a start time of the event, each respective reservation received from the one or more on-call user accounts prior to receipt of an indication of the event; and
wherein triggering one or more notifications further comprises:
sending a notification to at least one of the on-call user accounts to initiate a booking of the event.

7. The computer-implemented method of claim 1, further comprising:
identifying a plurality of worker user account segments and a plurality of business user accounts segment;
for one or more pairings between a respective worker user account and a respective business user account, determining one or more cut off thresholds for allowing one or more of the booking actions;
aggregating worker data related to one or more of the worker user accounts based on one or more worker user account features, event notifications and event attendance;
aggregating business data related to one or more of the business user accounts based on one or more business user account features and one or more event features; and
updating one or more of the worker user account segments and one or more of the business user account segments based at least in one of the aggregated worker data and the aggregated business data.

8. A system comprising one or more processors, and a non-transitory computer-readable medium including one or more sequences of instructions that, when executed by the one or more processors, cause the system to perform operations comprising:
generating a prediction, for one of a plurality of distinct sequential time ranges occurring prior to a start of an event, regarding a likelihood of an occurrence of an unattendance by one or more individuals at the event, each individual represented by a respective user account;
based on the prediction, triggering one or more booking actions specific to a particular time range of the prediction; and
triggering one or more notifications in accordance with the one or more booking actions for the event.

9. The system of claim 8, wherein generating a prediction comprises:
receiving an indication of the event during a first time range prior to the start of the event;
predicting a first unattendance likelihood for a possible first booking of the event by a first user account;
predicting a second unattendance likelihood for a possible second booking of the event by a second user account;
wherein triggering one or more booking actions specific to a particular time range of the prediction comprises:
due to the first unattendance likelihood, blocking user interaction activity of the first user account with the event; and
due to the second unattendance likelihood, allowing user interaction activity of the second user account with the event; and
wherein triggering one or more notifications comprises:
sending a notification of the event to the second user account.

10. The system of claim 8, wherein generating a prediction comprises:
receiving a booking of the event from a first user account;
triggering a time range subsequent to an initial time range based on the received booking; and
predicting a first unattendance likelihood for the booking of the event by a first user account;
wherein triggering one or more booking actions specific to a particular time range of the prediction comprises:
due to the first unattendance likelihood, allowing for overbooking of the event from one or more additional user account; and
wherein triggering one or more notifications comprises:
sending a request to a second user account to book the event after a total booking threshold for the event has been satisfied.

11. The system of claim 8, wherein generating a prediction comprises:
receiving a confirmation, within a defined time range prior to the start of the event, from a first user account that unattendance of the event will occur;
generating a first prediction of whether a booking request will be received from one or more user accounts having a current permission to book the event;
wherein triggering one or more booking actions specific to a particular time range of the prediction comprises:
based on the first prediction satisfying a threshold, allowing for a period of time during which a possible request to book the event may be received from the one or more user accounts having the current permission to book the event.

12. The system of claim 11, wherein triggering one or more notifications comprises:
sending a respective notification of the event to the one or more user accounts having the current permission to book the event.

13. The system of claim 11, wherein triggering one or more booking actions specific to a particular time range of the prediction comprises:
based on the first prediction failing to satisfy the threshold, identifying one or more on-call user accounts having a respective reservation for a period of time that includes a start time of the event, each respective reservation received from the one or more on-call user accounts prior to receipt of an indication of the event.

14. The system of claim 13, wherein triggering one or more notifications comprises:
sending a notification to at least one of the on-call user accounts to initiate a booking of the event.

15. A computer program product comprising a non-transitory computer-readable medium having a computer-readable program code embodied therein to be executed by one or more processors, the program code including instructions to:
generating a prediction, for one of a plurality of distinct sequential time ranges occurring prior to a start of an event, regarding a likelihood of an occurrence of an unattendance by one or more individuals at the event, each individual represented by a respective user account;
based on the prediction, triggering one or more booking actions specific to a particular time range of the prediction; and
triggering one or more notifications in accordance with the one or more booking actions for the event.

16. The computer program product of claim 15, wherein generating a prediction comprises:
receiving an indication of the event during a first time range prior to the start of the event;
predicting a first unattendance likelihood for a possible first booking of the event by a first user account;
predicting a second unattendance likelihood for a possible second booking of the event by a second user account;
wherein triggering one or more booking actions specific to a particular time range of the prediction comprises:
due to the first unattendance likelihood, blocking user interaction activity of the first user account with the event; and
due to the second unattendance likelihood, allowing user interaction activity of the second user account with the event; and
wherein triggering one or more notifications comprises:
sending a notification of the event to the second user account.

17. The computer program product of claim 15, wherein generating a prediction comprises:
receiving a booking of the event from a first user account;
triggering a time range subsequent to an initial time range based on the received booking; and
predicting a first unattendance likelihood for the booking of the event by a first user account;
wherein triggering one or more booking actions specific to a particular time range of the prediction comprises:
due to the first unattendance likelihood, allowing for overbooking of the event from one or more additional user account; and
wherein triggering one or more notifications comprises:
sending a request to a second user account to book the event after a total booking threshold for the event has been satisfied.

18. The computer program product of claim 15, wherein generating a prediction comprises:
receiving a confirmation, within a defined time range prior to the start of the event, from a first user account that unattendance of the event will occur;
generating a first prediction of whether a booking request will be received from one or more user accounts having a current permission to book the event;
wherein triggering one or more booking actions specific to a particular time range of the prediction comprises:
based on the first prediction satisfying a threshold, allowing for a period of time during which a possible request to book the event may be received from the one or more user accounts having the current permission to book the event.

19. The computer program product of claim 18, wherein triggering one or more notifications comprises:
sending a respective notification of the event to the one or more user accounts having the current permission to book the event.

20. The computer program product of claim 18, wherein triggering one or more booking actions specific to a particular time range of the prediction comprises:
based on the first prediction failing to satisfy the threshold, identifying one or more on-call user accounts having a respective reservation for a period of time that includes a start time of the event, each respective reservation received from the one or more on-call user accounts prior to receipt of an indication of the event; and
wherein triggering one or more notifications comprises:
sending a notification to at least one of the on-call user accounts to initiate a booking of the event.
